(19) United States
(12) Patent Application Publication
(10) Pub. No.: US 2016/0121822 A1
(43) Pub. Date: May 5, 2016

(54) HARNESS CLIP AND SYSTEM FOR CLIPPING WIRING HARNESS

(71) Applicant: INTERNATIONAL ENGINE INTELLECTUAL PROPERTY COMPANY, LLC, Lisle, IL (US)

(72) Inventors: Andrew SHAW, Oak Park, IL (US); Anthony M. ANELLO, Bartlett, IL (US)

(73) Assignee: International Engine Intellectual Property Company ,LLC.

(21) Appl. No.: 14/893,559

(22) PCT Filed: May 29, 2013
(86) PCT No.: PCT/US2013/043015

§ 371 Date: Nov. 24, 2015

(51) Int. Cl. B60R 16/02

(52) U.S. Cl. CPC B60R 16/0215

(57) ABSTRACT

A harness clip for clipping a wire to mounting supports of a vehicle includes a body and a tie-strap. The body includes a clip portion having a generally “U”-shaped channel for receiving the wire at an interior surface of body. The clip portion has two openings from the interior surface to an exterior surface opposite of the interior surface. The body also includes a mount-receiving portion extending from the clip portion. The mount-receiving portion includes two legs that are configured to engage the mounting supports. The tie-strap is engaged to the body and includes a cord that is inserted through the two openings in the clip portion of the body to generally encapsulate the wire with the clip portion. The tie-strap is configured to be tightened around at least a portion of the wire.

### BACKGROUND

Embodiments described herein relate generally to vehicle wiring harnesses, and more particularly, to a harness clip that is installed on a mounting support to clip a wire into position.

In motor vehicles, components such as the engine, the transmission, the drivetrain, and the exhaust system are mounted on a frame, and a wiring harness is used to transmit electrical power among the various components. By binding the plurality of wires into a harness, the wires can be better secured to the corresponding vehicle components. To avoid chafing and interference with vehicle or engine componentry, as well as to provide relief from mechanical strain on the wiring and connections, clips are used to position the wires, often by clipping one wire to another wire or by clipping wires to fuel lines or other components. Further, the wiring harness acid clips may be located adjacent to high temperature components, such as exhaust components and turbochargers, so the clip may be positioned to keep the wires from contacting or being in close proximity to the high temperature components.

Different vehicles may have different components and space limitations for accommodating the wiring harness, consequently the wiring may differ from vehicle to vehicle. Further, manufacture and installation of a wiring harness is typically done manually by an operator. Clipping of the wires often relies on the discretion of the operator. Wiring installed at the discretion of the operator within the context of an engine and vehicle with high temperatures, abrasive surfaces and significant mechanical motion stress, can potentially be installed in a manner that violates the engineering requirements for the wiring harness. As such, the installation may miss part of the engineering intent to protect the wiring from high temperatures, motion stress and sharp or abrasive surfaces. Available space considerations may render it difficult for the operator to connect and clip the wiring harness in a repeatable fashion.

Paint dots may be used to aid the operator in clip placement, but ultimately the position of the clips and the cables is not readily controlled in any direction or plane, which may lead to inconsistent routing of the wiring or clip omission. When the clip is attached to other wires or lines, the clip may slide with respect to the wire or line, also resulting in inconsistencies in wiring. The wiring harness of a vehicle or engine may be installed in a repeatable and consistent manner such that the harness may not be subjected to conditions (e.g. heat, motion or surface contact) that it was not intended to encounter. Commonly available wiring clips capable of withstanding high operating temperatures do not incorporate securing features to allow consistent and repeatable assembly and installation.

### SUMMARY

A harness clip for clipping a wire to mounting supports of a vehicle includes a body and a tie-strap. The body includes a clip portion having a generally “U”-shaped channel for receiving the wire at an interior surface of the body. The clip portion has two openings from the interior surface to an exterior surface opposite of the interior surface. The body also includes a mount-receiving portion extending from the clip portion. The mount-receiving portion includes two legs that are configured to engage the mounting supports. The tie-strap is engaged to the body and includes a cord that is inserted through the two openings in the clip portion of the body to generally encapsulate the wire with the clip portion. The tie-strap is configured to be tightened around at least a portion of the wire.

Another harness clip for clipping a wire to mounting supports of a vehicle includes a body and a tie-strap. The body includes a clip portion having a channel for receiving the wire at an interior surface of channel. The channel generally circumscribes an axis defined by the wire, and the clip portion has two openings through tile body from the interior surface to an exterior surface opposite of the interior surface. A mount-receiving portion extends from the clip portion and is configured to engage the mounting supports. The tie-strap is engaged to the body and has a one-way locking mechanism. A cord extends from the locking mechanism and is engaged with the two openings in the clip portion of the body. The tie-strap is configured to form a tightenable loop around the exterior surface of the body.

A harness clip system for clipping wires on a wiring harness to mounting supports having predetermined locations on the vehicle includes at least one harness clip configured to be permanently attached to the wiring harness at predetermined locations along the wire. The predetermined locations of the harness clips are to be aligned with the predetermined locations on the mounting supports.

### BRIEF DESCRIPTION OF THE DRAWINGS

FIG. 1 is a perspective view of a harness clip.

FIG. 2 is a perspective view of two harness clips having tie straps attached around a wire of a wiring harness.

FIG. 3 is a perspective view of the harness clip tightened around the wire of the wiring harness.

FIG. 4 is a section view of the wire, and a harness clip attached around the wire and mounted to a mounting support.

FIG. 5 is a front view of the harness clip attached around the wiring harness and mounted to the mounting support

FIG. 6 is an installation diagram for the placement of the harness clips on the wiring in a pre-determined configuration that aligns with pre-determined positions on an engine or other component.

### DETAILED DESCRIPTION

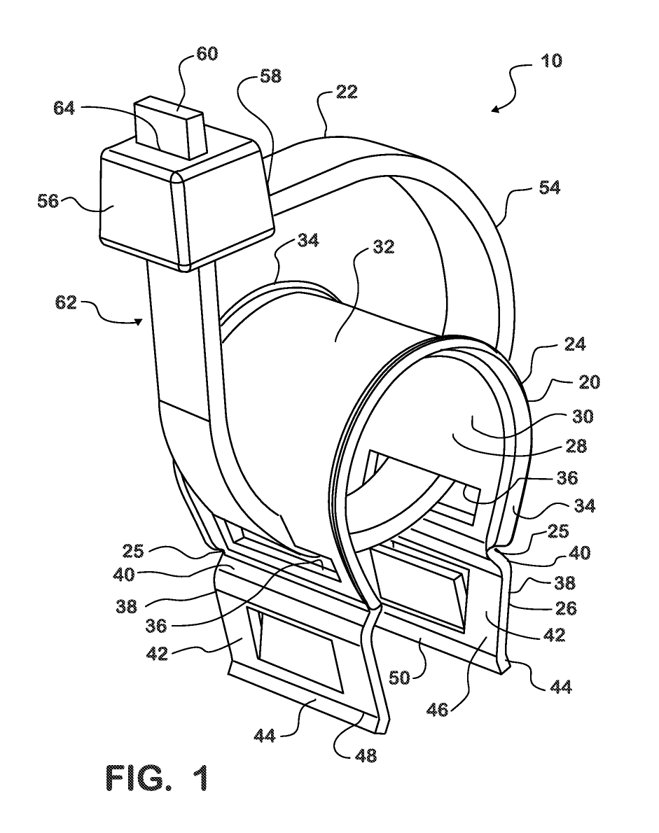

Referring to FIGS. 1-6, a harness clip for a wiring harness 12 of a vehicle 14 is indicated generally at 10. The harness clip 10 will be described with respect to being mounted to a mounting support 16, such as a bracket on an engine, however other mounting supports are possible. The harness clip 10 clips a wire 18 of the wiring harness 12 and mounts the wire to mounting supports 16 to avoid chafing of the wire or interference with vehicle componentry. Further, the harness clip 10 is used to position the wire 18 away from high temperature components. The term “wire” should be construed broadly to refer to a single wire or may refer to a bundle of wires, and may refer to wiring from a wiring harness 12 or wiring not connected to a wiring harness.

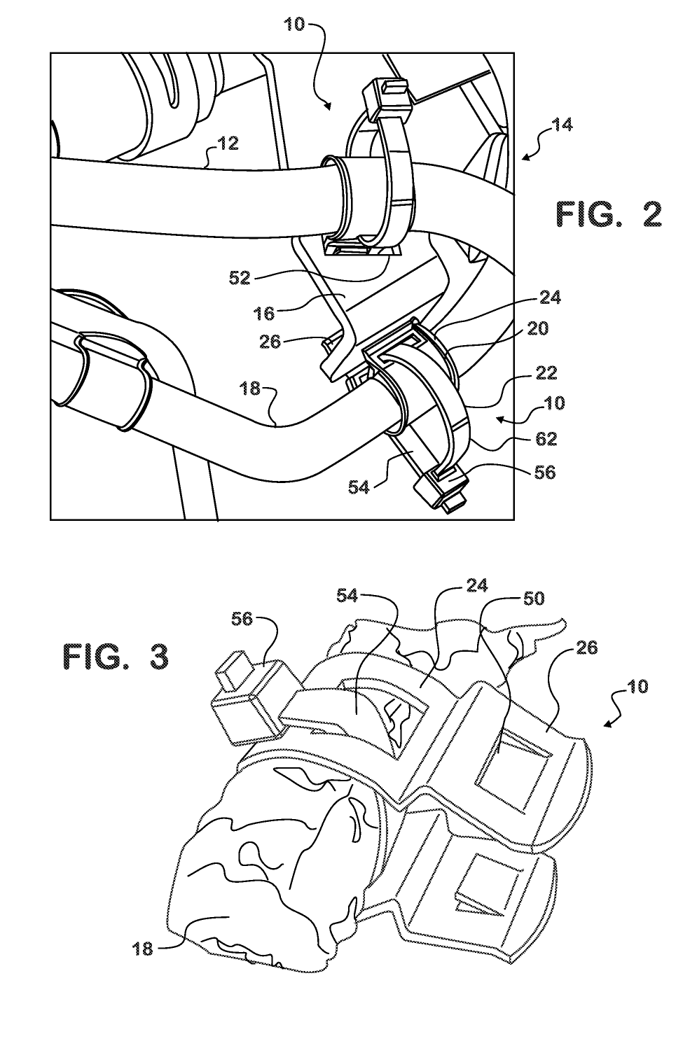

The harness clip 10 includes a body 20 and a tie-strap 22 extending from the body. Having a clip portion 24 and a mount-receiving portion 26, the body 20 both partially encapsulates the wire 18 at the clip portion and mounts to the mounting support 16 with the mount-receiving portion. Referring to FIGS. 2-3, the tie-strap 22 secures the clip portion 24 around the wire 18.

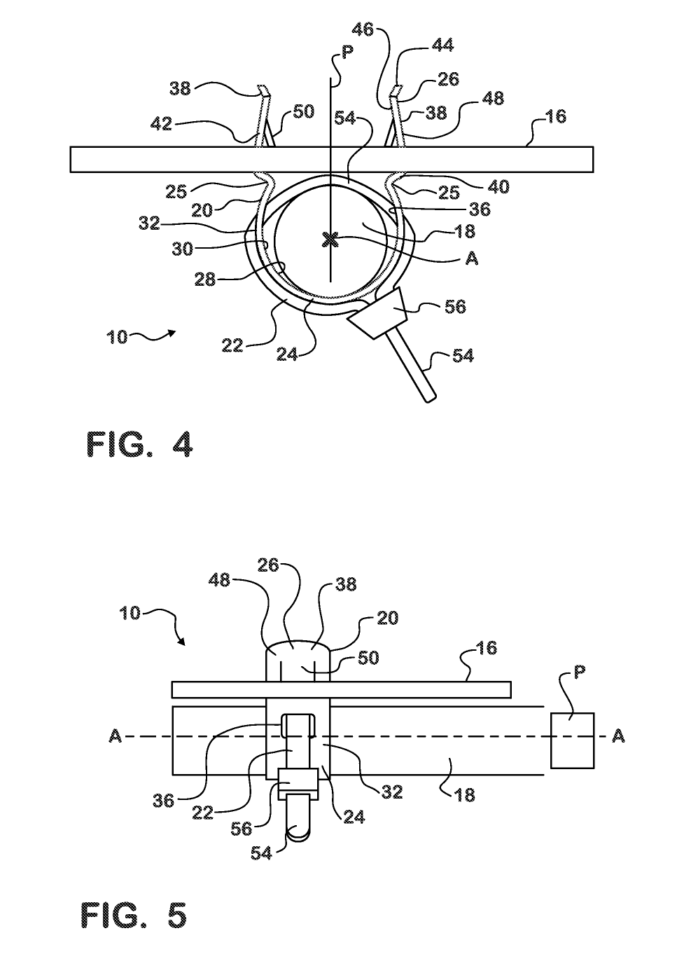

The clip portion 24 of the body 20 is generally partially cylindrical, forming a channel 28 for receiving the wire 18 at an interior surface 30 of the channel. The channel 28 may be U-shaped, and may have a depth that is greater than one half the external diameter of the wire 18. The channel 28 may generally circumscribe an axis A defined by the wire 18 (See FIGS. 4 and 5). Opposite the interior surface 30 is an exterior surface 32. Both the interior surface 30 and the exterior surface 32 may be generally partially cylindrical or “U”-shaped. The clip portion 24 may have a rolled or angled edge 34 between the interior surface 30 and the exterior surface 32 to avoid fraying or interference with the wire 18 at locations of entry to and exit from the channel 28.

Two openings 36 are formed through the clip portion 24 of the body 20 from the interior surface 30 to the exterior surface 32, and may be generally rectangular in shape, and may be generally radially disposed on the channel 28, however other shapes are contemplated. The openings 36 receive the tie strap 22, which is fed through one of the openings 36, from the exterior surface 32 to the interior surface 30, into the interior of the channel 28, and is then is fed out through the other opening, from the interior surface to the exterior surface, to the exterior of the body 20. Tie strap 22 is located around the external diameter of the wire 18.

Extending from the ends 25 of the generally “U”-shaped clip portion 24 is the mount-receiving portion 26, which includes two generally symmetric legs 38 that engage with the mounting support 16. The two legs 38 of the mount-receiving portion 26 are symmetric about a plane P formed along the length of the channel 28 and through the axis A formed at the center of the channel 28. Each leg 38 may have a shoulder section 40 that is curved outwardly away from the plane P and a guide section 42 that is slanted inwardly towards the plane P. A foot 44 may be disposed at the end of each leg 38 and be angled outwardly away from the plane P.

The mount-receiving portion 26 may have an interior surface 46 and an exterior surface 48 opposite the interior surface. On each leg 38 at the interior surface 46, a retaining flange 50 may extend inwardly towards the plane P. The retaining flange 50 may be stamped out from the guide section 42 of the legs 38, and may be generally rectangular in shape, however other configurations are possible.

Referring to FIGS. 2, 4-5, the retaining flange 50 is configured to snap into set positions on the mounting supports 16. The legs 38 are inserted into apertures 52 on the mounting supports 16, and the retaining flanges 50 are elastically deformed as the flanges are fed through the apertures. When received through the apertures 52, the retaining flanges 50 elastically spring back and lock the legs 38 of the mount-receiving portion 26 to the mounting supports 16.

The tie-strap 22 includes a cord 54 and a locking mechanism 56. A first end 58 of the cord 54 extends from the locking mechanism 56, and a second end 60 of the cord is engaged with the clip portion 24. In use, when the wire 18 is received in the channel 28, the second end 60 of the cord 54 is fed through one of the openings 36, from the exterior surface 32 to the interior surface 30 of the clip portion 24, around the wire 18, and out through the other opening, from the interior surface to the exterior surface of the clip portion. When the second end 60 of the cord 54 is received at the locking mechanism 56, the tie-strap 22 forms a tightenable loop 62. Together, the clip portion 24 and the cord 54 encapsulate the wire 18 generally 360-degrees around the exterior diameter of the wire, and the cord 54 can be tightened to draw the channel 28 tighter around the wire 18. Alternately to being received in an enclosed opening 36, the cord 54 may be received in a partial opening such as a hook-shaped element.

The second end 60 of the cord 54 is then received in a locking channel 64 of the locking mechanism 56. As seen in FIGS. 3-5, the second end 60 is drawn through the locking mechanism 56 to tighten the cord 54 around the wire 18. With the tie-strap 22, the locking mechanism 56 only permits movement of the cord 54 in one-direction such that the mechanism permanently locks the cord as it is tightened, however other configurations are possible.

The harness clip 10 may be manufactured of steel, however other materials are possible. The clip portion 24 may be flexible enough to allow the insertion of the wire 18 into the channel 28, and to spring back after insertion, and may be flexible enough to be drawn tighter as the cord 54 around the clip portion 24 is tightened. Further, the mount-receiving portion 26 may be flexible enough to allow the insertion of the legs 38 into the mounting supports 16. The tie strap 22 may be formed of plastic or nylon, however other materials are possible.

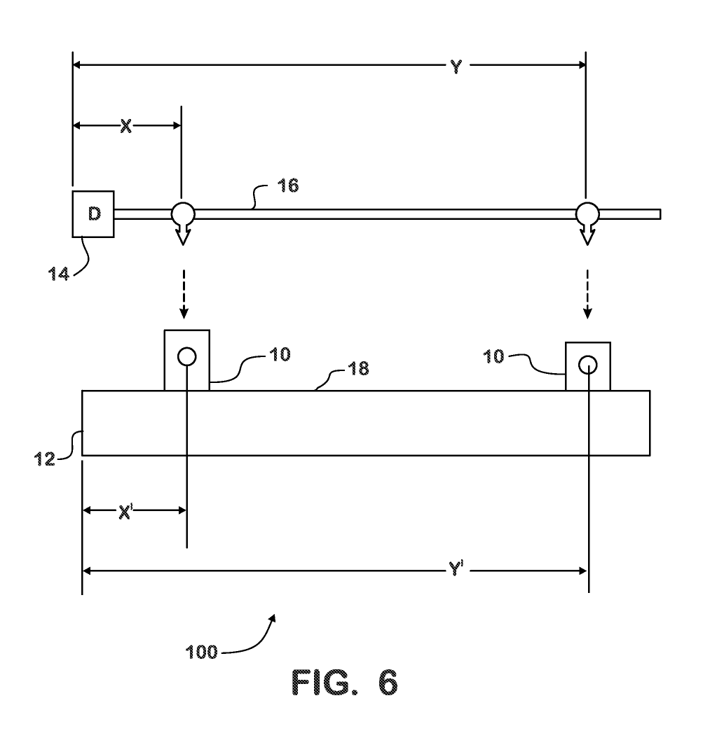

Referring now to FIG. 6, a system 100 for clipping wires 18 on a wiring harness 12 to mounting supports 16 using the harness clip 10 includes permanent installation of the harness clip 10 onto the wire 18 at predetermined locations along the wire or wiring harness, which may be reflected in drawings. Additionally, the system 100 incorporates predetermined positions of the mounting supports 16 on the engine or other components, which may also be reflected in drawings. The predetermined locations of the harness clips 10 are configured to be aligned to the predetermined locations of the mounting supports 16.

With the harness clip 10, and the system of use 100, the harness clips have pre-determined, repeatable mounting positions for holding wires 18 of the wiring harness 12. Positioning of the harness clips 10 on the harness system 100 may be determined by drawings. Using the drawings, a user can repeat and inspect the wiring and the harness clips 10 on the vehicle 14 using the system 100. For example, a first mounting support 16 position may be located a pre-determined distance X from a datum D on the vehicle 14, and the first harness clip 10 may be located a predetermined distance X′ along the length of the wiring harness 12 such that the positions are aligned. A second mounting support 16 position may be located a pre-determined distance Y from a datum D on the vehicle 14, and the second harness clip 10 may be located a pre-determined distance Y′ along the length of the wring harness 12. The harness clips 10 may be permanently installed in the wiring 18. In an alternate embodiment, it is possible that the harness clips 10 are removably installed on the wiring 18.

While the harness clip 10 and system 100 was explained with reference to use on a wiring harness 12 of a vehicle, it should be appreciated that the harness clip 10 and system 100 can be used in any vehicle application where wires 18 are to be mounted in a predetermined location to mounting supports.

What is claimed is:

1) A harness clip for clipping a wire to mounting supports of a vehicle, the harness clip comprising:
a body comprising:
a clip portion having a generally “U”-shaped channel for receiving the wire at an interior surface of body, the clip portion having two openings from the interior surface to an exterior surface opposite of the interior surface;
a mount-receiving portion extending from the clip portion, the mount-receiving portion including two legs configured to engage the mounting supports;
a tie-strap engaged to the body, the tie-strap including a cord that is inserted through the two openings in the clip portion of the body to generally encapsulate the wire with the clip portion, wherein the tie-strap is configured to be tightened around at least a portion of the wire.

2) The harness clip of claim 1 wherein the tie-strap further comprises a locking mechanism, wherein the cord has a first end extending from the locking mechanism, the cord is received in the two openings in the clip portion, and the second end of the cord is received through the locking mechanism to form a tightenable loop.

3) The harness clip of claim 2 wherein the locking mechanism only permits movement of the cord through a locking channel in one direction to tighten the loop.

4) The harness clip of claim 1 further comprising a rolled edge on the clipping portion of the body at the location of entry and exit of the wire in the channel.

5) The harness clip of claim 1 wherein the two legs of the mount-receiving portion are symmetric about a plane formed along the length of the channel and through an axis formed at the center of the channel.

6) The harness clip of claim 5 wherein the two legs each have a shoulder portion that extends from the clip portion and that is curved outwardly with respect to the plane.

7) The harness clip of claim 6 wherein the two legs each have a guide section that extends from the shoulder portion and that is slanted inwardly with respect to the plane.

8) The harness clip of claim 7 wherein the two legs each have a retaining flange that extends from the guide section inwardly with respect to the plane.

9) A harness clip for clipping a wire to mounting supports of a vehicle, the harness clip comprising:
a body comprising:
a clip portion having a channel for receiving the wire at an interior surface of channel, the channel generally circumscribing an axis defined by the wire, the clip portion having two openings through the body from the interior surface to an exterior surface opposite of the interior surface;
a mount-receiving portion extending from the clip portion, the mount-receiving portion configured to engage the mounting supports; and
a tie-strap engaged to the body, the tie-strap comprising:
a one-way locking mechanism; and
a cord that extends from the locking mechanism and that is engaged with the two openings in the clip portion of the body, wherein the tie-strap is configured to form a tightenable loop around the exterior surface of the body.

10) The harness clip of claim 9 wherein the cord has a second end that is received through the locking mechanism to form the tightenable loop.

11) The harness clip of claim 9 wherein the mount-receiving portion further comprises two legs extending from each end of the clip portion.

12) The harness clip of claim 11 wherein the two legs are symmetric about a plane formed along the length of the channel and through an axis formed at the center of the channel.

13) The harness clip of claim 11 wherein the two legs each have a shoulder portion that extends from the clip portion and that is curved outwardly with respect to the plane.

14) The harness clip of claim 11 wherein the two legs each have a retaining flange that extends inwardly with respect to the plane.

15) A harness clip system for clipping wires on a wiring harness to mounting supports having predetermined locations on the vehicle, the system comprises:
at least one harness clip configured to be permanently attached to the wiring harness at predetermined locations along the wire, wherein the predetermined locations of the harness clips are alignable with the predetermined locations on the mounting supports.
